(19) United States
(12) Patent Application Publication
(10) Pub. No.: US 2024/0224105 A1
(43) Pub. Date: Jul. 4, 2024

(54) COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi Hu, Dongguan (CN); Xinlei Yu, Dongguan (CN)

(73) Assignee: GUANGDONG OPPO MOBILE TELECOMMUNICATIONS CORP., LTD., Dongguan (CN)

(21) Appl. No.: 18/608,010

(22) Filed: Mar. 18, 2024

Related U.S. Application Data
(63) Continuation of application No. PCT/CN2021/120160, filed on Sep. 24, 2021.

(51) Int. Cl. H04W 24/10

(52) U.S. Cl. CPC H04W 24/10

(57) ABSTRACT

A method for communication includes that: one or more early measurement results of one or more target cells are obtained, where each of the one or more early measurement results includes respective location-related information; and the one or more early measurement results are transmitted to a network device. A terminal device and a network device are also provided.

### CROSS-REFERENCE TO RELATED APPLICATION

This application is a U.S. continuation application of International Application No. PCT/CN2021/120160, entitled “COMMUNICATION METHOD AND APPARATUS”, filed on Sep. 24, 2021. The content of this application is hereby incorporated by reference in its entirety.

### TECHNICAL FIELD

The present disclosure relates to the technical field of communications, and in particular to a communication method, a terminal device and a network device.

### BACKGROUND

When there is an early measurement result that can be reported by a terminal device, a network device can instruct the terminal device to report the early measurement result. The network device determines a fast configuration or activation operation of carrier aggregation (CA)/dual connectivity (DC) based on the early measurement result.

At present, the early measurement result mainly includes a reference signal receiving power (RSRP)/reference signal receiving quality (RSRQ) of a cell or a beam. The network device performs the fast configuration or activation operation based on the RSRP/RSRQ.

In non-terrestrial networks (NTN), the RSRP/RSRQ cannot accurately reflect the channel quality. Therefore, the network device may activate or configure the secondary cell with a poor channel quality when performing the fast configuration or activation operation only based on the RSRP/RSRQ, thus affecting the subsequent data transmission efficiency of the terminal device in the secondary cell.

### SUMMARY

The embodiments of the present disclosure provide a communication method, a terminal device and a network device, which can solve the problem of an error in judging the channel quality caused by a measurement error of the RSRP/RSRQ.

In the first aspect, the embodiments of the present disclosure provide a communication method. The method is applicable to a terminal device, and the method includes the following operations.

One or more early measurement results of one or more target cells are obtained. Each of the one or more early measurement results includes respective location-related information.

The one or more early measurement results are transmitted to a network device.

In the second aspect, the embodiments of the present disclosure provide a network device, which includes a transceiver and a processor.

The transceiver is configured to receive, from a terminal device, one or more early measurement results of one or more target cells. Each of the one or more early measurement results includes respective location-related information.

The processor is configured to determine, based on the one or more early measurement results, one or more to-be-configured or to-be-activated cells in the one or more target cells.

In the third aspect, the embodiments of the present disclosure provide a terminal device, which includes a processor and a transceiver.

The processor is configured to obtain one or more early measurement results of one or more target cells. Each of the one or more early measurement results includes respective location-related information.

The transceiver is configured to transmit the one or more early measurement results to a network device.

### BRIEF DESCRIPTION OF THE DRAWINGS

FIG. 1 is a first schematic diagram of architecture of a communication system provided by an embodiment of the present disclosure.

FIG. 2 is a second schematic diagram of architecture of a communication system provided by an embodiment of the present disclosure.

FIG. 3 is a schematic diagram of carrier aggregation (CA) provided by an embodiment of the present disclosure.

FIG. 4 is a schematic diagram of dual connectivity (DC) provided by an embodiment of the present disclosure.

FIG. 5 is a schematic flowchart of a communication method provided by an embodiment of the present disclosure.

FIG. 6 is a schematic flowchart of a communication method provided by an embodiment of the present disclosure.

FIG. 7 is a first schematic structural diagram of a communication apparatus provided by an embodiment of the present disclosure.

FIG. 8 is a second schematic structural diagram of a communication apparatus provided by an embodiment of the present disclosure.

FIG. 9 is a schematic structural diagram of a network device provided by an embodiment of the present disclosure.

FIG. 10 is a schematic structural diagram a terminal device provided by an embodiment of the present disclosure.

### DETAILED DESCRIPTION

In order to better understand the technical solutions of the present disclosure, related concepts and related technologies involved in the present disclosure are introduced in the following.

The terminal device usually has a wireless transceiver function. The terminal device may be deployed on land, which includes the indoor or outdoor, hand-held, wearable or vehicle-mounted device. The terminal device may also be deployed on the water (such as ships, etc.). The terminal device may also be deployed in the air (such as airplanes, balloons and satellites, etc.). The terminal device may be a mobile phone, a tablet computer (Pad), a computer with a wireless transceiver function, a virtual reality (VR) terminal device, an augmented reality (AR) terminal device, a wireless terminal in an industrial control, a vehicle-mounted terminal device, a wireless terminal in self driving, a wireless terminal device in a remote medical, a wireless terminal device in a smart grid, a wireless terminal device in a transportation safety, a wireless terminal device in a smart city, a wireless terminal device in a smart home, and a wearable terminal device, etc. The terminal device involved in the embodiments of the present disclosure may also be referred to as a terminal, a user equipment (UE), an access terminal device, a vehicle-mounted terminal, an industrial control terminal, a UE unit, a UE station, a mobile station, a mobile stage, a remote station, a remote terminal device, a mobile device, a UE terminal device, a wireless communication device, a UE agent or a UE device, etc. The terminal device may also be fixed or mobile.

The network device usually has a wireless transceiver function. The network device may have mobile characteristics, for example, the network device may be a mobile device. Alternatively, the network device may be a communication satellite or a balloon station. For example, the type of the communication satellite may be a low earth orbit (LEO) satellite, a medium earth orbit (MEO) satellite, a geostationary earth orbit (GEO) satellite, a high elliptical orbit (HEO) satellite and so on according to different orbital altitudes. For example, the range of the orbital altitude of the LEO satellite is usually 500 km˜1500 km, and the orbital period (the period of rotation around the Earth) is about 1.5 hours˜2 hours. The signal propagation delay of the single-hop communication between users is about 20 ms, and the single-hop communication delay between users refers to a transmission delay between a terminal device and a network device, or a delay between a network device and a transmission device. The maximum visible time of a satellite is about 20 minutes, which refers to the longest time that a beam of the satellite covers a certain area on the ground. The LEO satellite moves relative to the ground, and the area on the ground covered by the LEO satellite also changes with the movement of the satellite. The LEO satellite has a short signal propagation distance, a low link loss and a low transmission power requirement for terminal device. The orbital altitude of the GEO satellite is usually 35,786 km and the orbital period is 24 hours. The signal propagation delay of the single-hop communication between users is about 250 ms. In order to ensure the coverage of the satellite and improve the system capacity of the communication network, the satellite may cover the ground with multiple beams. For example, one satellite may form dozens or hundreds of beams to cover the ground, and one beam may cover the area of the ground with a diameter of tens to hundreds of kilometers. Of course, the network device may also be a base station arranged on land, water, or the like. For example, the network device may be a next generation NodeB (gNB) or a next generation-evolved NodeB (ng-eNB). The gNB provides the UE with the user plane function and control plane function of the new radio (NR), and ng-eNB provides the UE with the user plane function and control plane function of evolved universal terrestrial radio access (E-UTRA). It should be noted that the gNB and the ng-eNB are only names, which are used to represent base stations supporting 5G network systems and have no limiting significance. The network device may also be a base transceiver station (BTS) in a global system for mobile communications (GSM) system or a code division multiple access (CDMA) system, a nodeB (NB) in a wideband code division multiple access (WCDMA) system, or an evolutionary node B (eNB or eNodeB) in a long term evolution (LTE) system. Alternatively, the network device may also be a relay station, an access point, a vehicle-mounted device, a wearable device, a network side device in a network after 5G, a network device in a future evolved public land mobile network (PLMN) network, a road site unit (RSU), and the like.

The non-terrestrial network is known as NTN for short. The NTN technology usually uses a manner of the satellite communication to provide communication services to terminal device on the ground. Compared with terrestrial cellular network communication, the satellite communication has many unique advantages. Firstly, the satellite communication is not limited by a region. For example, general land communication cannot cover areas such as oceans, mountains, deserts, etc., where communication device cannot be set up or communication coverage cannot be done due to sparse population. For the satellite communication, because a satellite can cover a large area on the ground and the satellite can orbit around the earth, theoretically every corner of the earth can be covered by the satellite communication. Secondly, the satellite communication has great social value. The remote mountainous areas and poor and backward countries or regions can be covered by the satellite communication at a lower cost, so that users in these areas can enjoy the advanced voice communication and mobile Internet technology, which is conducive to narrowing the digital divide with developed areas and promoting the development of these areas. Thirdly, the satellite communication distance is long, and the communication cost does not increase significantly with the increase of communication distance. Finally, the satellite communication has high stability and is not limited by natural disasters.

In order to ensure the coverage of the satellite and improve the system capacity of the entire satellite communication system, the satellite cover the ground with multiple beams, and one satellite may form dozens or even hundreds of beams to cover the ground. One satellite beam may cover the area of the ground with a diameter of tens to hundreds of kilometers.

Radio resource control (RRC) state: the terminal device and the network device communicate with each other through wireless channels and exchange information with each other; therefore, a control mechanism is needed between the terminal device and the network device to exchange information and reach an agreement, which is referred to as the RRC. In the LTE, the RRC state includes a RRC idle state (RRC_IDLE) and a RRC connected state (RRC_CONNECTED). In 5G NR, besides the RRC_IDLE state and the RRC_CONNECTED state, a RRC inactive state (RRC_INACTIVE) is further introduced. In the RRC_INACTIVE state, the terminal device and the network device are in a non-connected state, but the context of the terminal device is still partially retained. At the same time, in the RRC_INACTIVE state, the terminal device may quickly switch to the RRC_CONNECTED state through a paging message and the like.

In the RRC_IDLE state, the mobility is UE-based cell selection/reselection, the paging is initiated by a core network (CN), and the paging area is configured by the CN. No UE AS context exists on the base station side. No RRC connection exists.

In the RRC_CONNECTED state, there is an RRC connection, and both the base station and the UE have the UE AS context. The network side knows that the location of the UE is at a specific cell level. The mobility is controlled by the network side. Unicast data may be transmitted between the UE and the base station.

In the RRC_INACTIVE state, the mobility is UE-based cell selection/reselection, there is a connection between the CN and the NR, the UE AS context exists on a certain base station, the paging is triggered by a radio access network (RAN), the RAN-based paging area is managed by the RAN, and the network side knows that the location of the UE is at a RAN-based paging area level.

Time advance is known as TA for short.

Round-trip Time is known as RTT for short.

Global navigation satellite system is known as GNSS for short.

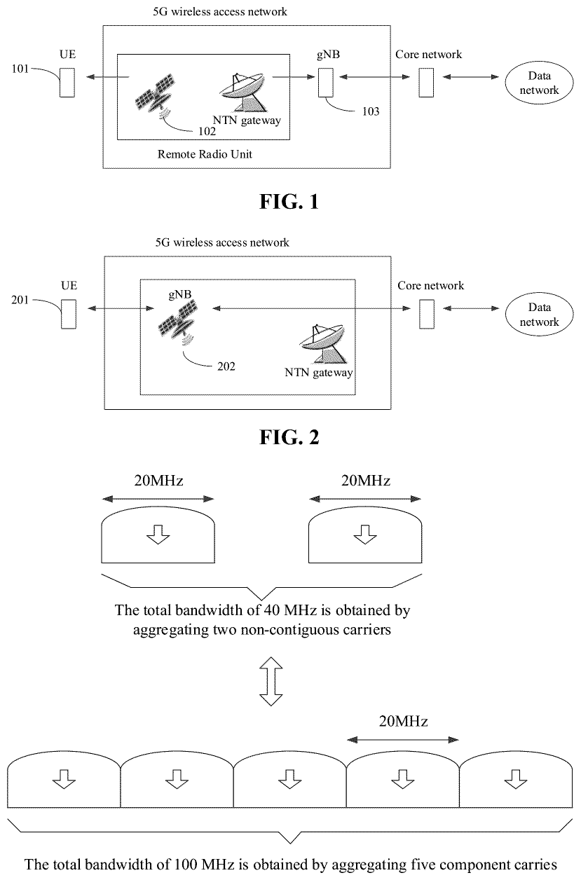

After explaining the related concepts involved in the present disclosure, the architectures of the communication system in the present disclosure will be explained with reference to FIG. 1 and FIG. 2.

FIG. 1 is the first schematic diagram of architecture of a communication system provided by an embodiment of the present disclosure. Referring to FIG. 1, the communication system includes a terminal device 101, a satellite 102 and a base station 103. Wireless communication may be performed between the terminal device 101 and the satellite 102, and communication may be performed between the satellite 102 and the base station 103. The network formed among the terminal device 101, the satellite 102 and the base station 103 may also be referred to as the NTN. In the architecture of the communication system illustrated in FIG. 1, the satellite 102 does not have the function of a base station (gNB), and the communication between the terminal device 101 and the base station 103 needs to be relayed through the satellite 102. The base station 103 is connected to the data network through a core network. In this system architecture, the base station 103 may be referred to as a network device, and the satellite 102 is a relay device between the terminal device 101 and the base station 103.

FIG. 2 is the second schematic diagram of architecture of a communication system provided by an embodiment of the present disclosure. Referring to FIG. 2, the communication system includes a terminal device 201 and a satellite 202. Wireless communication may be performed between the terminal device 201 and the satellite 202. The network formed between the terminal device 201 and the satellite 202 may also be referred to as the NTN. In the architecture of the communication system illustrated in FIG. 2, the satellite 202 functions as a base station (gNB), and direct communication may be performed between the terminal device 201 and the satellite 202. The satellite 202 is connected to the data network through a core network. In this system architecture, the satellite 202 may be referred to as a network device.

The carrier aggregation (CA) and dual connectivity (DC) are introduced below.

The CA is a technology for increasing system transmission bandwidth to meet the requirements for high speed and system capacity improvement. The CA enables the NR system to support larger bandwidth by jointly scheduling and using resources on multiple component carriers (CC), thus achieving higher system peak rate.

Based on the continuity of the aggregated carriers in the spectrum, the type of CA may include contiguous CA and non-contiguous CA. Based on whether the frequency bands of the aggregated carriers are the same, the type of CA may include intra-band CA and inter-band CA. In a multi-carrier system, the terminal device may have multiple carrier resources at the same time, including primary cell component (PCC) and secondary cell component (SCC). For a terminal device, there is only one PCC, which undertakes the functions of control plane and user plane, provides RRC signaling connection, non-access stratum (NAS) function, security, etc. The physical uplink control channel (PUCCH) exists on the PCC and only on the PCC. The SCC only undertakes data transmission function and provides additional wireless resources. The serving cell on the PCC is referred to as the primary serving cell, the serving cell on the SCC is referred to as the secondary serving cell, and the primary serving cell and the secondary serving cell are collectively referred to as the serving cell.

FIG. 3 is a schematic diagram of CA provided by an embodiment of the present disclosure. As illustrated in FIG. 3, a bandwidth of each carrier is 20 MHz, the total bandwidth of 40 MHz may be obtained by aggregating two non-contiguous carriers (i.e., two frequency-disperse component carriers), and the total bandwidth of 100 MHz may be obtained by aggregating five contiguous carriers. The aggregated carriers belong to the same base station. All aggregated carriers use the same cell-radio network temporary identifier (C-RNTI), and the base station ensures that the confliction does not occur in the C-RNTI of the cell where each carrier is located. Because the asymmetric CA and the symmetric CA are supported, it is required that a downlink carrier must be included in the aggregated carriers, but an uplink carrier may be not included. Moreover, there must be the physical downlink control channel (PDCCH) and the PUCCH for the PCC cell, and only the PCC cell has the PUCCH, and other SCC cells may have the PDCCH.

The CA has been described in the above-mentioned embodiment, and the related contents of the DC will be described below.

In order to increase user throughput and enhance mobile performance, the DC technology is proposed. In the DC technology, the terminal device may establish communication connections with the master network device and the secondary network device at the same time, and realize data transmission with the core network through the master network device and the secondary network device.

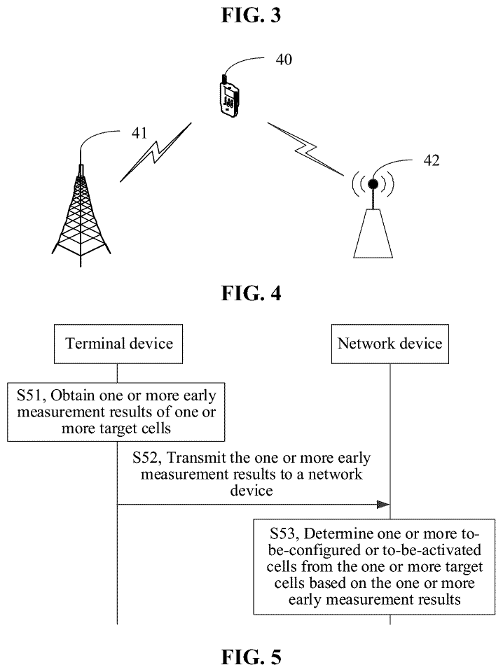

FIG. 4 is a schematic diagram of DC provided by an embodiment of the present disclosure. As illustrated in FIG. 4, a terminal device 40 that supports the DC may simultaneously establish communication connections with two network devices, i.e., the first network device 41 and the second network device 42 in FIG. 4. Through the DC technology, the CA may be realized by using non-ideal backhaul X2 interface, thus providing a higher rate for the terminal device.

The two network devices include a master network device (for example, a master gNB (MgNB)) and a secondary network device (for example, a secondary gNB (SgNB)). The master network device and the secondary network device may be connected through the non-ideal backhaul. In the communication system illustrated in FIG. 4, a terminal device 40 supporting the DC is configured with at least two cell groups, one being a master cell group (MCG) and the other being a secondary cell group (SCG). The MCG refers to a cell group associated with the above master network device. The MCG includes a primary cell (PCell) and may also include one or more secondary cells (Scell). The PCell is a cell that establishes RRC connection with the terminal device. The SCG refers to a cell group associated with the secondary network device. The SCG includes a primary secondary cell (PSCell) and one or more secondary cells. The PSCell is an only secondary cell configured with the PUCCH resource in the SCG.

The CA or DC operation may be performed by the network device. Specifically, the terminal device may perform measurement, such as CA measurement or DC measurement, under the configuration of the network device, to obtain a measurement result, and then report the measurement result to the network device. After obtaining the measurement result, the network device may configure the CA cell or DC cell, i.e., perform CA/DC operation, for the terminal device according to the measurement result.

Taking activating a Scell in the CA as an example, the Scell is configured through RRC dedicated signaling. An initial configuration state is a deactivated state, in which data cannot be sent and received. Data can be sent and received only after activating the Scell through a media access control (MAC) control element (CE). From the perspective of Scell configuration and activation delay, this architecture is not an optimal one. However, this delay reduces the efficiency of CA usage and radio resources, especially in small cell deployment scenarios. In a dense small cell deployment scenario, signaling load of each Scell is also very great, especially when each Scell needs to be configured separately. Therefore, the current CA architecture introduces extra delay, which limits the use of CA and reduces the gain of sharing of the CA load.

In general, the first RRC reconfiguration message of the NR system cannot configure the appropriate CA or MR-DC function for the UE, because the network side has not obtained the measurement result of the UE at this time. The measurement task is usually configured through the first RRC reconfiguration message, and the network can configure the appropriate CA or MR-DC function according to the measurement report result. In the implementation process, the delay of this process is relatively great because it takes a period of time from performing the measurement by the UE to reporting the measurement result. In order to fast configure the Scell or the SCG, the network may instruct UE to perform early measurement in the RRC_IDLE state or the RRC_INACTIVE state, and report the measurement result to the network device when entering the RRC_CONNECTED state. The network device may fast configure the Scell or SCG according to the early measurement result. The measurement target frequencies configured by the gNB may include a NR frequency list and an E-UTRAN frequency list. The NR frequency list only supports the measurement for the synchronization signal and PBCH block (SSB), but does not support the measurement for the channel state information-reference signal (CSI-RS). The SSB frequencies include a synchronous SSB and an asynchronous SSB.

The early measurement is configured through the dedicated signaling RRC Release message or the system broadcast (the original SIB4 and newly introduced SIB11). The measurement configuration in the system broadcast is common for UE in the RRC_IDLE state and UE in the RRC_INACTIVE state. If the configuration for the early measurement is received through the RRC Release message, its contents overwrite the measurement configuration obtained from the system broadcast. If the NR frequency configured by the RRC Release message does not contain configuration information of the SSB, configuration information of the SSB in the SIB11 or SIB4 will be used.

Only when the cell system broadcast indicates that the current cell supports early measurement reporting (that is, idleModeMeasurements), the UE will indicate, through a parameter (idleMeasAvailable) in the RRCSetupComplete message or RRCResumeComplete message, whether the UE has a measurement result of early measurement that can be reported. Then, the network device side instructs, through the UEInformationRequest, the UE to report the early measurement result in the UEInformationResponse message. For the UE in the RRC_INACTIVE state, the request and report of the early measurement result may also be completed through the RRCResume message and the RRCResumeComplete message, respectively.

The UE needs to complete the early measurement within a specified period of time, which is controlled by T331 configured in the RRC Release message. The UE will start this timing after obtaining the measurement configuration of the early measurement. The UE does not need to stop this timer when transitioning between the RRC_INACTIVE state and RRC_IDLE state. The early measurement may also need to be performed within the validity area (validity AreaList). The validity area may be configured through dedicated signaling or SIB 11. The validity area consists of a frequency and a list of cells within the frequency. If there is no validity area configured on the network side, it means that there is no measurement area restriction.

In the current NR system, the measurement results (measResultIdleNR) reported by the UE to the network device (such as a base station) are mainly the RSRP/RSRQ results of the cells and the RSRP/RSRQ results of beams. The network device determines the fast configuration or activation operation of the CA/DC based on these RSRP/RSRQ results.

Compared with the NR terrestrial network, a space path loss between the UE and the satellite in the NTN changes less significantly with distance. In this way, when the measurement value error of the RSRP/RSRQ is considered, the actual coverage of UE in the network will not be accurately described, that is, the channel quality will not be accurately reflected. If the network device still only relies on the RSRP/RSRQ reported by the UE, the fast activation or configuration of a Scell with a poor channel quality will be caused, which will affect the subsequent data transmission efficiency of the Scell, and further affect the service experience of the terminal.

Based on this, the embodiment of the present disclosure provides a communication method to improve the accuracy of judgment for the channel quality, and assist the network device to activate or configure a cell with the better channel quality, thereby improving the subsequent data transmission efficiency of the terminal device on the cell. The solutions of the present disclosure are introduced below.

FIG. 5 is a schematic flowchart of a communication method provided by an embodiment of the present disclosure. As illustrated in FIG. 5, the method includes the following operations.

In S51, a terminal device obtains one or more early measurement results of one or more target cells. Each of the one or more early measurement results includes respective location-related information.

The terminal device may perform measurement according to the configuration by the network device. Since the terminal device needs a period of time from the beginning of measurement to reporting the measurement result, in order to fast configure or activate a cell, the network device may instruct the terminal device to measure the cell in early in an idle state or an inactive state to obtain the early measurement result of the target cell. The number of target cells may be one or more.

The early measurement result may include, for example, a RSRP of a cell, a RSRQ of a cell, a RSRP of a beam, a RSRQ of a beam, etc. In the embodiments of the present disclosure, the early measurement result further includes location-related information, which reflects the location information of the terminal device, such as a distance from the terminal device to a satellite, a distance from the terminal device to a ground reference point of a cell, a TA value from the terminal device to a cell, and so on.

In S52, the terminal device transmits the one or more early measurement results to a network device.

Based on the configuration of the network device, the terminal device may perform measurements when it is in an idle state or an inactive state to obtain the early measurement results of the target cells, and then transmit the early measurement results of the multiple cells to the network device when it is in a connected state based on the configuration of the network device.

The terminal device may perform the measurement on one or more cells to obtain one or more early measurement results of the one or more cells. When reporting to the network device, the terminal device may report all the early measurement results of the one or more cells on which the measurement have been performed to the network device, and at this time, all the one or more cells are target cells. The terminal device may also report only a measurement result of a cell that satisfies a condition among the one or more cells to the network device, while a measurement result of a cell not satisfying the condition are not reported to the network device. At this time, only the cell satisfying the condition is the target cell in the one or more cells.

In S53, the network device determines one or more to-be-configured or to-be-activated cells in the one or more target cells based on the one or more early measurement results.

After obtaining the one or more early measurement results of the one or more target cells, the network device determines the one or more to-be-configured or to-be-activated cells based on the one or more early measurement results of the one or more target cells. Each of the one or more early measurement results includes respective location-related information, and the network device may determine the one or more to-be-configured or to-be-activated cells in combination with the location-related information.

Specifically, the network device may select one or more cells with better channel quality in the multiple cells in combination with the location-related information to perform CA operation, and activate the one or more cells to be the one or more Scells of the terminal device. The network device may also select a cell with better channel quality in the multiple cells in combination with the location-related information to perform DC operation, and configure the cell to be the PSCell of the terminal device.

In the communication method provided by the embodiment of the present disclosure, firstly, the terminal device obtains the one or more early measurement results of the one or more target cells, and then transmits the one or more early measurement results to the network device. After receiving the one or more early measurement results of the one or more target cells, the network device may determine the one or more to-be-configured or to-be-activated cells in the one or more target cells according to the one or more early measurement results. Because the early measurement result includes the location-related information, the network device may evaluate the channel quality based on the RSRP or RSRQ in combination with the location-related information. Compared with the solution of evaluating the channel quality only based on the RSRP or RSRQ, the error in judging the channel quality caused by the measurement error can be reduced effectively, which is helpful for the network device to activate or configure the cell with better channel quality, thereby improving the subsequent data transmission efficiency of the terminal device on the cell.

The solutions of the present disclosure are described in detail in combination with the accompanying drawings.

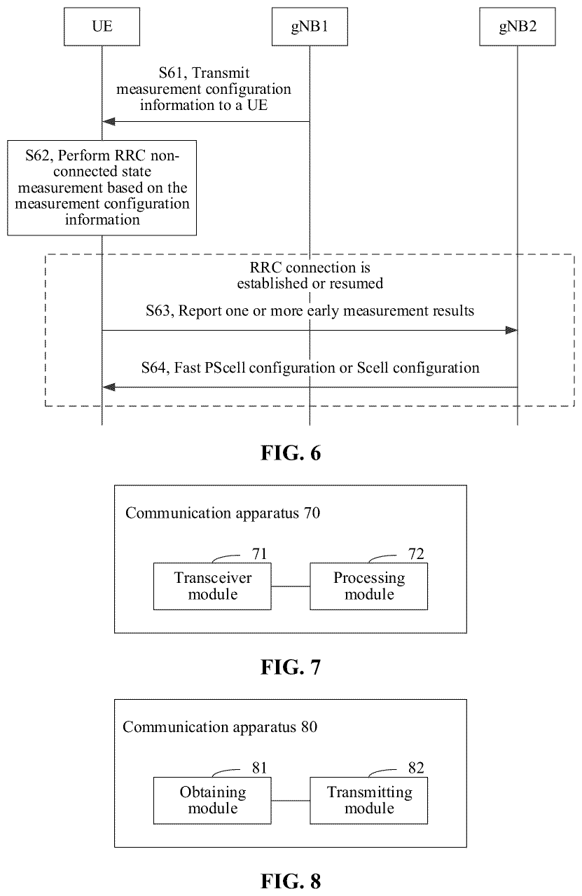

FIG. 6 is a schematic flowchart of the communication method provided by an embodiment of the present disclosure. As illustrated in FIG. 6, the method includes the following operations.

In S61, a gNB1 transmits measurement configuration information to a UE.

In some embodiments, the gNB1 may transmit the measurement configuration information directly to the UE. Alternatively, the gNB1 may transmit the measurement configuration information through other messages.

For example, the measurement configuration information may be configured through a SIB message. The network device transmits the SIB message to the terminal device, where the SIB message includes the measurement configuration information. The terminal device receives the SIB message from the network device, and obtains the measurement configuration information based on the SIB message.

For example, the measurement configuration information may be configured through a RRC dedicated signaling. The network device transmits the RRC signaling to the terminal device, where the RRC signaling includes the measurement configuration information. The terminal device receives the RRC signaling from the network device, and obtains the measurement configuration information based on the RRC signaling.

The measurement configuration information includes at least one of location reporting assistance information or location reporting condition information. When the location reporting assistance information is included in the measurement configuration information, the network device may directly transmit the location reporting assistance information to the terminal device. Alternatively, the network device may transmit a SIB message to the terminal device. where the SIB message includes the location reporting assistance information. The terminal device receives the SIB message from the network device and obtains the location reporting assistance information based on the SIB message. Alternatively, the network device may transmit RRC signaling to the terminal device, where the RRC signaling includes the location reporting assistance information. The terminal device receives the RRC signaling from the network device and obtains the location reporting assistance information based on the RRC signaling.

When the location reporting condition information is included in the measurement configuration information, the network device may directly transmit the location reporting condition information to the terminal device. Alternatively, the network device may transmit a SIB message to the terminal device, where the SIB message includes the location reporting condition information. The terminal device receives the SIB message from the network device and obtains the location reporting condition information based on the SIB message. Alternatively, the network device may transmit RRC signaling to the terminal device, where the RRC signaling includes the location reporting condition information. The terminal device receives the RRC signaling from the network device and obtains the location reporting condition information based on the RRC signaling.

When the measurement configuration information includes location reporting assistance information and location reporting condition information, the network device may directly transmit the location reporting assistance information and location reporting condition information to the terminal device. Alternatively, the network device may also transmit a SIB message to the terminal device, where the SIB message includes the location reporting assistance information and the location reporting condition information. The terminal device receives the SIB message from the network device and obtains the location reporting assistance information and the location reporting condition information based on the SIB message. Alternatively, the network device may transmit RRC signaling to the terminal device, where the RRC signaling includes the location reporting assistance information and the location reporting condition information. The terminal device receives the RRC signaling from the network device and obtains the location reporting assistance information and the location reporting condition information based on the RRC signaling.

When the measurement configuration information includes the location reporting assistance information, the location reporting assistance information is used to assist the terminal device to obtain the location-related information.

In embodiments of the present disclosure, the location reporting assistance information may include ephemeris information of a satellite associated with one or more cells, and/or one or more ground reference points of one or more cells.

The ephemeris information of the satellite may include, for example, satellite velocity information, satellite orbit information, ephemeris reference time, eccentricity and the like. The network device may configure the ephemeris information of the satellite associated with one or more cells in the location reporting assistance information. After receiving the ephemeris information of the satellite associated with one or more cells, the terminal device may perform measurement based on the ephemeris information of the satellite to obtain the location-related information. For example, a distance from the terminal device to a satellite, a RTT value from the terminal device to the satellite and the like may be obtained based on the ephemeris information of the satellite.

A ground reference point of a cell is predefined, that is, when deploying the network, the reference point of the cell/beam corresponding to the satellite is predefined. The network device may configure one or more ground reference points of one or more cells in the location reporting assistance information. After receiving the one or more ground reference points of one or more cells, the terminal device may perform measurement based on the one or more ground reference points of the one or more cells to obtain location-related information, for example, the distance from the terminal device to the ground reference point of the cell, the TA value from the terminal device to the cell, the RTT value from the terminal device to the cell and the like may be obtained based on the one or more ground reference points of the one or more cells.

When the location reporting condition information is included in the measurement configuration information, one or more reporting conditions may be included in the location reporting condition information. The UE may perform measurements on multiple cells, and then only report an early measurement result of a cell satisfying the reporting condition among the multiple cells to the network side based on the indication of the location reporting condition information.

In one possible embodiment, the location reporting condition information may include at least one of the following: a first distance threshold from the terminal device to a satellite, a second distance threshold from the terminal device to a cell ground reference point, a TA threshold from the terminal device to a cell, a first RTT threshold from the terminal device to a cell, or a second RTT threshold from the terminal device to the satellite.

When the location reporting condition information includes the first distance threshold from the terminal device to the satellite, the location reporting condition information indicates that an early measurement result of a cell is reported only when a distance from the terminal device to the satellite associated with the cell is less than or equal to the first distance threshold.

When the location reporting condition information includes the second distance threshold from the terminal device to the ground reference point of the cell, the location reporting condition information indicates that an early measurement result of a cell is reported only when a distance from the terminal device to the ground reference point of the cell is less than or equal to the second distance threshold.

When the location reporting condition information includes the TA threshold from the terminal device to the cell, the location reporting condition information indicates that an early measurement result of a cell is reported only when a TA value from the terminal device to the cell is less than or equal to the TA threshold.

When the location reporting condition information includes the first RTT threshold from the terminal device to the cell, the location reporting condition information indicates that an early measurement result of a cell is reported only when a RTT value from the terminal device to the cell is less than or equal to the first RTT threshold.

When the location reporting condition information includes the second RTT threshold from the terminal device to the satellite, the location reporting condition information indicates that an early measurement result of a cell is reported only when a RTT value from the terminal device to the satellite associated with the cell is less than or equal to the second RTT threshold.

In S62, the UE performs RRC non-connected state measurement based on the measurement configuration information.

After receiving the measurement configuration information from the network device, the terminal device performs measurement based on the measurement configuration information to obtain the early measurement result of the target cell. For an early measurement result of any one cell, the early measurement result may include location-related information, and may further include channel state information.

The location-related information may include at least one of the following: a distance from the terminal device to an satellite, a distance from the terminal device to a ground reference point of the cell, a TA value from the terminal device to the cell, a RTT value from the terminal device to the cell, a RTT value from the terminal device to the satellite, or a GNSS location of the terminal device. The channel state information includes at least one of the following: a RSRP of a cell, a RSRQ of the cell, a RSRP of a beam, or a RSRQ of the beam.

In the NTN, the terminal device is located within the coverage of a beam or cell corresponding to a satellite. The satellite may be a base station corresponding to a terminal device or a relay device between the terminal device and the base station. When the satellite is the relay device, data transmitted between the terminal device and the base station needs to be forwarded through the satellite. During the operation of the satellite, the distance between the satellite and the terminal device may be changed. The location-related information may include the distance from the terminal device to the satellite. Specifically, when the network device configures the ephemeris information of the satellite in the measurement configuration information, the terminal device may obtain the distance from the terminal device to the satellite based on the ephemeris information of the satellite.

The ground reference point of the cell is a pre-defined reference point of the cell/beam corresponding to the satellite. The ground reference point of the cell may be, for example, a center point of the cell. When the terminal device performs measurement, the distance from the terminal device to the ground reference point of the cell may be obtained. Specifically, when the network device configures one or more ground reference points of one or more cells in the measurement configuration information, the terminal device may obtain the distance from the terminal device to the ground reference point of the cell based on the ground reference point. The ground reference point may be, for example, the center point of the cell.

The location-related information may further include a TA value from the terminal device to a cell.

The RTT value from the terminal device to the cell is the RTT value when the terminal device transmits a signal through the cell. For example, the terminal device may obtain the RTT value from the terminal device to the cell based on the distance from the terminal device to the cell and the speed of signal transmission. When the network device configures the ground reference point of the cell in the measurement configuration information, the RTT value from the terminal device to the cell may be obtained by obtaining the distance from the terminal device to the ground reference point of the cell.

The RTT value from the terminal device to the satellite is the RTT value when the terminal device transmits a signal through the satellite. For example, the terminal device may obtain the RTT value from the terminal device to the satellite based on the distance from the terminal device to the satellite and the speed of signal transmission. When the network device configures the ephemeris information of the satellite in the measurement configuration information, the RTT value from the terminal device to the satellite may be obtained by obtaining the distance from the terminal device to the satellite.

Alternatively, the terminal device may further obtain its own GNSS location. Specifically, when the network device configures the ephemeris information of the satellite in the measurement configuration information, the terminal device may obtain the GNSS location of the terminal device based on the ephemeris information of the satellite.

When the early measurement result includes the location-related information and the channel state information, one possible implementation is that the terminal device performs the measurement based on the measurement configuration information to obtain location-related information and channel state information of at least one cell, and then determines one or more target cells from the at least one cell based on the location-related information to obtain one or more early measurement results of the one or more target cells. In the subsequent reporting, the one or more early measurement results of the one or more target cells are reported to the network device. For example, the terminal device measures three cells based on the measurement configuration information, and obtains location-related information and channel state information of these three cells. If location-related information of only two of the three cells satisfies the requirement, the two cells satisfying the requirement are determined as target cells, and the terminal device only reports the early measurement results of the two target cells to the network device. The early measurement results include the location-related information and channel state information of the target cells.

Another possible implementation is that the terminal device firstly performs location measurement based on the measurement configuration information to obtain location-related information of at least one cell, and then determines one or more target cells from the at least one cell based on the location-related information of the at least one cell. After determining the one or more target cells, channel state measurement is performed only on the one or more target cells to obtain channel state information of the one or more target cells. Finally, one or more early measurement results of the one or more target cells may be obtained based on the channel state information and location-related information of the one or more target cells. For example, the terminal device performs the location measurement on three cells based on the measurement configuration information, and obtains location-related information of these three cells. If the location-related information of only two of the three cells satisfies the requirement, the two cells satisfying the requirement are determined as target cells. Then, the terminal device performs channel state measurement on the two target cells to obtain channel state information of the two target cells. The terminal device only reports the early measurement results of the two target cells to the network device. The early measurement results include the location-related information and channel state information of the target cells.

In the above embodiments, the location-related information of the cell satisfies the requirement, which may refer to the requirement indicated in the location reporting condition information. For example, when the location-related information includes the distance from the terminal device to the satellite, if the distance is less than or equal to the first distance threshold, the location-related information satisfies the requirement. When the location-related information includes the distance from the terminal device to the ground reference point of the cell, if the distance is less than or equal to the second distance threshold, the location-related information satisfies the requirement. When the location-related information includes the TA value from the terminal device to the cell, if the TA value is less than or equal to the TA threshold, the location-related information satisfies the requirement. When the location-related information includes the RTT value from the terminal device to the cell, if the RTT value is less than or equal to the first RTT threshold, the location-related information satisfies the requirement. When the location-related information includes the RTT value from the terminal device to the satellite, if the RTT value is less than or equal to the second RTT threshold, the location-related information satisfies the requirement, and so on. The requirement satisfied by the location-related information may include one or more of the above requirements, and each threshold may be set as required.

In S63, the UE reports one or more early measurement results of one or more target cells to the gNB2.

After the RRC connection is established or resumed, the terminal device may report the one or more early measurement results of the one or more target cells to the network device. Specifically, when the cell system broadcast indicates that the current cell supports early measurement reporting, the terminal device indicates, through a parameter (idleMeasAvailable) in the RRCSetupComplete message or RRCResumeComplete message, whether the terminal device has a measurement result of the early measurement that can be reported. Then, the network device requests the terminal device to report the early measurement result in the UEInformationResponse message through the UEInformationRequest. For the UE in the RRC_INACTIVE state, the request and report of the early measurement result may also be completed through the RRCResume message and the RRCResumeComplete message, respectively.

Taking measResultIdleNR in the UEInformationResponse message as an example, the RRC message may be expended as follows:

```
--ASN1START
--TAG-MEASRESULTIDLENR-START
MeasResultIdleNR-r16 ::= SEQUENCE {
    measResultServingCell-r16 SEQUENCE {
        rsrp-Result-r16 RSRP-Range
OPTIONAL,
        rsrq-Result-r16 RSRQ-Range
OPTIONAL,
            resultsSSB-Indexes-r16 ResultsPerSSB-IndexList-r16
    OPTIONAL,
        },
        measResultPerCarrierListIdleNR-r16 SEQUENCE (SIZE (1..maxFreqIdle-r16)) OF
MeasResultsPerCarrierIdleNR-r16 OPTIONAL,
        ...
        [[
        locationResultServingCell LocationResult
        ]]
    }
    MeasResultsPerCellIdleNR-r16 ::= SEQUENCE {
        carrierFreq-r16 ARFCN-ValueNR,
        measResultsPerCellListIdleNR-r16 SEQUENCE (SIZE (1..maxCellMeasIdle-r16)) OF
MeasResultsPerCellIdleNR-r16,
        ...
}
    MeasResultsPerCellIdleNR-r16 ::= SEQUENCE {
        phyCellId-r16 PhysCellId,
        measResultNR-r16 SEQUENCE {
            rsrp-Result-r16 RSRP-Range
    OPTIONAL,
            rsrq-Result-r16 RSRQ-Range
    OPTIONAL,
            resultsSSB-Indexes-r16 ResultsPerSSB-IndexList-r16
    OPTIONAL,
        },
        ...
        [[
        locationResultServingCell LocationResult
        ]]
    }
```

Based on the above contents, it may be determined that when the terminal device reports the early measurement result, the early measurement result may include location-related information and channel state information. The channel state information may include a RSRP of a cell, a RSRP of a beam, a RSRQ of a cell, a RSRQ of a beam, or the like. In practice, the early measurement results is not limited to be reported through UEInformationResponse message, but may also be completed through the RRCResume message or the RRCResumeComplete message.

The terminal device may report the early measurement results of all the measured cells to the network device, or may report part of the early measurement results of the measured cells to the network device. In the embodiment of the present disclosure, the gNB1 and the gNB2 may be the same network device or different network devices.

Since the terminal device performs the measurement based on the measurement configuration information configured by the network device, the measurement configuration information includes at least one of the location reporting assistance information or the location reporting condition information. When the measurement configuration information does not include the location reporting condition information, the terminal device may report the early measurement results of all the measured cells to the network device. When the measurement configuration information includes the location reporting condition information, the terminal device may report the early measurement result of the cell satisfying the location reporting condition information among all the measured cells to the network device.

For example, when the location reporting condition information includes the first distance threshold from the terminal device to the satellite, the terminal device reports only an early measurement result of a cell for which the distance from the terminal device to the satellite is less than or equal to the first distance threshold among the measured cells. Therefore, in the early measurement result of the target cell reported by the terminal device, the distance from the terminal device to the satellite associated with the target cell is less than or equal to the first distance threshold.

For example, when the location reporting condition information includes the second distance threshold from the terminal device to a ground reference point of a cell, the terminal device reports only an early measurement result of a cell for which the distance from the terminal device to the ground reference point of the cell is less than or equal to the second distance threshold among the measured cells. Therefore, in the early measurement result of the target cell reported by the terminal device, the distance from the terminal device to the ground reference point of the target cell is less than or equal to the second distance threshold.

For example, when the location reporting condition information includes the TA threshold from the terminal device to the cell, the terminal device reports only an early measurement result of a cell for which the TA value from the terminal device to the cell is less than or equal to the TA threshold among the measured cells. Therefore, in the early measurement result of the target cell reported by the terminal device, the TA value from the terminal device to the target cell is less than or equal to the TA threshold.

For example, when the location reporting condition information includes the first RTT threshold from the terminal device to the cell, the terminal device reports only an early measurement result of a cell for which the RTT value from the terminal device to the cell is less than or equal to the first RTT threshold among the measured cells. Therefore, in the early measurement result of the target cell reported by the terminal device, the RTT value from the terminal device to the target cell is less than or equal to the first RTT threshold.

For example, when the location reporting condition information includes the [00111] second RTT threshold from the terminal device to the satellite, the terminal device reports only the early measurement result of a cell for which the RTT value from the terminal device to the satellite is less than or equal to the second RTT threshold among the measured cells. Therefore, in the early measurement result of the target cell reported by the terminal device, the RTT value from the terminal device to the satellite associated with the target cell is less than or equal to the second RTT threshold.

When the early measurement result includes the location-related information and the RSRP/RSRQ of the cell and/or the RSRP/RSRQ of the beam, a possible implementation is that the terminal device obtains location-related information of N (N is a positive integer) cells and RSRP/RSRQ of the cells and/or RSRP/RSRQ of the beams, then determines the cell satisfying the condition as the target cell, and reports the early measurement result of the target cell to the network device. A possible implementation is that the terminal device obtains location-related information of N cells, determines the target cell satisfying the condition based on the location-related information among the N cells, then obtains the cell RSRP/RSRQ and/or the beam RSRP/RSRQ of the target cell, and reports the early measurement result of the target cell to the network device. The satisfied condition may be, for example, the condition indicated by the location reporting condition information in the measurement configuration information.

In S64, the gNB2 performs fast PScell configuration or Scell configuration for the UE.

The network device obtains the early measurement result of the target cell. The early measurement result includes the location-related information. The location-related information includes at least one of the following: the distance from the terminal device to the satellite, the distance from the terminal device to the ground reference point of the cell, the TA value from the terminal device to the cell, the RTT value from the terminal device to the cell, the RTT value from the terminal device to the satellite, or the GNSS location of the terminal device. The early measurement result may further include one or more of the RSRP of the cell, the RSRQ of the cell, the RSRP of the beam or the RSRQ of the beam. Based on the location-related information reported by the terminal device, combined with the cell RSRP/RSRQ and/or the beam RSRP/RSRQ, the network device determines the cell with better channel quality for fast configuration or activation among the multiple cells, and performs the fast CA or DC operation. For example, a cell with better channel quality may be determined to be configured as a PScell among the multiple cells, or a cell with better channel quality may be determined to be configured as a Scell among the multiple cells, and so on.

One possible implementation is that when the early measurement result includes the location-related information, the network device determines a to-be-configured or to-be-activated cell among the target cells based on the location-related information. For example, when the location-related information includes the distance from the terminal device to the satellite, a threshold may be set, and a corresponding target cell for which the distance from the terminal device to the satellite is less than the threshold in the early measurement results may be determined as the to-be-configured or to-be-activated cell, or a corresponding target cell with the minimum distance from the terminal device to the satellite in the early measurement results may be directly determined as the to-be-configured or to-be-activated cell.

For example, when the location-related information includes the distance from the terminal device to the ground reference point of the cell, a threshold may be set, and a corresponding target cell for which the distance from the terminal device to the ground reference point of the cell is less than the threshold in the early measurement results may be determined as the to-be-configured or to-be-activated cell, or a corresponding target cell with the minimum distance from the terminal device to the ground reference point of the cell in the early measurement results may be directly determined as the to-be-configured or to-be-activated cell.

For example, when the location-related information includes the TA value from the terminal device to the cell, a threshold may be set, and a corresponding target cell for which the TA value from the terminal device to the cell is less than the threshold in the early measurement results may be determined as the to-be-configured or to-be-activated cell, or a corresponding target cell with the minimum TA value from the terminal device to the cell in the early measurement results may be directly determined as the to-be-configured or to-be-activated cell.

For example, when the location-related information includes the RTT value from the terminal device to the cell, a threshold may be set, and a corresponding target cell for which the RTT value from the terminal device to the cell is less than the threshold in the early measurement results may be determined as the to-be-configured or to-be-activated cell, or a corresponding target cell with the minimum RTT value from the terminal device to the cell in the early measurement results may be directly determined as the to-be-configured or to-be-activated cell.

For example, when the location-related information includes the RTT value from the terminal device to the satellite, a threshold may be set, and a corresponding target cell for which the RTT value from the terminal device to the satellite is less than the threshold in the early measurement results may be determined as the to-be-configured or to-be-activated cell, or a corresponding target cell with the minimum RTT value from the terminal device to the satellite in the early measurement results may be directly determined as the to-be-configured or to-be-activated cell.

When the location-related information includes the above multiple items, a cell satisfying multiple corresponding conditions may be determined as a to-be-configured or to-be-activated cell, or a cell satisfying some of the multiple conditions may be determined as a to-be-configured or to-be-activated cell.

One possible implementation is that when the early measurement result includes the RSRP/RSRQ of the cell and/or the RSRP/RSRQ of the beam, the network device may determine a to-be-configured or to-be-activated cell in the target cells based on the RSRP/RSRQ of the cell and/or the RSRP/RSRQ of the beam. Taking the RSRP of a cell as an example, after obtaining RSRPs of target cells, a RSRP threshold may be set, and a target cell for which the RSRP value is greater than or equal to the RSRP threshold may be determined as a to-be-configured or to-be-activated cell, or a target cell with the maximum RSRP value may be determined as a to-be-configured or to-be-activated cell, and so on.

When the early measurement result includes the location-related information and the RSRP/RSRQ of the cell and/or the RSRP/RSRQ of the beam, the network device may determine the to-be-configured or to-be-activated cell in the target cells based only on the location-related information, or may determine the to-be-configured or to-be-activated cell in the target cells based only on the RSRP/RSRQ of the cell and/or the RSRP/RSRQ of the beam, or may determine the to-be-configured or to-be-activated cell in the target cells based on the location-related information and the RSRP/RSRQ of the cell and/or the RSRP/RSRQ of the beam.

Taking the early measurement result including the location-related information and the RSRP of the cell as an example, the network device may determine the target cell which simultaneously satisfies a condition corresponding to the location-related information and a condition corresponding to the RSRP of the cell as the to-be-configured or to-be-activated cell. The network device may also set different weights for the location-related information and the RSRPs of the cells, and determine the to-be-configured or to-be-activated cell in the target cells based on the corresponding weights.

In the communication method provided by the embodiments of the present disclosure, the terminal device first obtains early measurement results of multiple cells, and then transmits the early measurement results to the network device. After receiving the early measurement results of the multiple cells, the network device can determine one or more to-be-configured or to-be-activated cells in the multiple cells based on the early measurement results. Because the early measurement result includes the location-related information, the network device can evaluate the channel quality by combining the RSRP or RSRQ and the location-related information. Compared with the solution of evaluating the channel quality only based on the RSRP or RSRQ, the error in judging the channel quality caused by the measurement error can be reduced effectively, which is helpful for the network device to activate or configure the cell with better channel quality, thereby improving the subsequent data transmission efficiency of the terminal device on the secondary cell.

FIG. 7 is a first schematic structural diagram of a communication apparatus provided by an embodiment of the present disclosure. As illustrated in FIG. 7, the communication apparatus 70 includes a transceiver module 71 and a processing module 72.

The transceiver module 71 is configured to receive, from a terminal device, one or more early measurement results of one or more target cells. Each of the one or more early measurement results includes respective location-related information.

The processing module 72 is configured to determine, based on the one or more early measurement results, one or more to-be-configured or to-be-activated cells in the one or more target cells.

In a possible embodiment, the location-related information includes at least one of: a distance from the terminal device to an satellite; a distance from the terminal device to a ground reference point of a cell; a TA value from the terminal device to the cell; a RTT value from the terminal device to the cell; a RTT value from the terminal device to the satellite; or a GNSS location of the terminal device.

In a possible embodiment, the transceiver module 71 is further configured to transmit measurement configuration information to the terminal device before receiving, from the terminal device, the one or more early measurement results of the one or more target cells.

In a possible embodiment, the transceiver module 71 is specifically further configured to transmit a SIB message to the terminal device, the SIB message including the measurement configuration information; or transmit a RRC signaling to the terminal device, the RRC signaling including the measurement configuration information.

In a possible embodiment, the measurement configuration information includes at least one of: location reporting assistance information; or location reporting condition information.

In a possible embodiment, the location reporting assistance information includes at least one of: ephemeris information of a satellite associated with one or more cells; or one or more ground reference points of one or more cells.

In a possible embodiment, the location reporting condition information includes at least one of: the first distance threshold from the terminal device to a satellite; the second distance threshold from the terminal device to a ground reference point of a cell; a TA threshold from the terminal device to the cell; the first RTT threshold from the terminal device to the cell; or the second RTT threshold from the terminal device to the satellite.

In a possible embodiment, at least one of the following applies:
when the location reporting condition information includes the first distance threshold, a distance from the terminal device to a satellite associated with the one or more target cells is less than or equal to the first distance threshold;
when the location reporting condition information includes the second distance threshold, a distance from the terminal device to one or more ground reference points of the one or more target cells is less than or equal to the second distance threshold;
when the location reporting condition information includes the TA threshold, a TA value from the terminal device to the one or more target cells is less than or equal to the TA threshold;
when the location reporting condition information includes the first RTT threshold, a RTT value from the terminal device to the one or more target cells is less than or equal to the first RTT threshold; or
when the location reporting condition information includes the second RTT threshold, a RTT value from the terminal device to a satellite associated with the one or more target cells is less than or equal to the second RTT threshold.

In a possible embodiment, the early measurement result further includes channel state information, the channel state information including at least one of: a RSRP of a cell; a RSRQ of the cell; a RSRP of a beam; or a RSRQ of the beam.

The communication apparatus provided by the embodiment of the present disclosure may perform the technical solutions illustrated in the above method embodiments, and its realization principle and beneficial effect are similar, so it will not be repeated in the present disclosure.

FIG. 8 is a second schematic structural diagram of a communication apparatus provided by an embodiment of the present disclosure. As illustrated in FIG. 8, the communication apparatus 80 includes an obtaining module 81 and a transmitting module 82.

The obtaining module 81 is configured to obtain one or more early measurement results of one or more target cells. Each of the one or more early measurement results includes respective location-related information.

The transmitting module 82 is configured to transmit the one or more early measurement results to a network device.

In a possible embodiment, the location-related information includes at least one of: a distance from the terminal device to an satellite; a distance from the terminal device to a ground reference point of a cell; a TA value from the terminal device to the cell; a RTT value from the terminal device to the cell; a RTT value from the terminal device to the satellite; or a GNSS location of the terminal device.

In a possible embodiment, the obtaining module 81 is further configured to: before obtaining the one or more early measurement results of the one or more target cells, receive measurement configuration information from the network device; and perform an measurement based on the measurement configuration information to obtain the one or more early measurement results of the one or more target cells.

In a possible embodiment, the obtaining module 81 is specifically further configured to: receive a SIB message from the network device and obtain the measurement configuration information based on the SIB message; or, receive a RRC signaling from the network device and obtain the measurement configuration information based on the RRC signaling.

In a possible embodiment, the measurement configuration information includes at least one of: location reporting assistance information; or location reporting condition information.

In a possible embodiment, the location reporting assistance information includes at least one of: ephemeris information of a satellite associated with one or more cells; or one or more ground reference points of one or more cells.

In a possible embodiment, the location reporting condition information includes at least one of: the first distance threshold from the terminal device to a satellite; the second distance threshold from the terminal device to a ground reference point of a cell; the TA threshold from the terminal device to the cell; the first RTT threshold from the terminal device to the cell; or the second RTT threshold from the terminal device to the satellite.

In a possible embodiment, at least one of the following applies:
when the location reporting condition information includes the first distance threshold, a distance from the terminal device to a satellite associated with the one or more target cells is less than or equal to the first distance threshold;
when the location reporting condition information includes the second distance threshold, a distance from the terminal device to one or more ground reference points of the one or more target cells is less than or equal to the second distance threshold;
when the location reporting condition information includes the TA threshold, a TA value from the terminal device to the one or more target cells is less than or equal to the TA threshold;
when the location reporting condition information includes the first RTT threshold, a RTT value from the terminal device to the one or more target cells is less than or equal to the first RTT threshold; or
when the location reporting condition information includes the second RTT threshold, a RTT value from the terminal device to a satellite associated with the one or more target cells is less than or equal to the second RTT threshold.

In a possible embodiment, the early measurement result further includes channel state information, the channel state information including at least one of: a RSRP of a cell; a RSRQ of the cell; a RSRP of a beam; or a RSRQ of the beam.

In a possible embodiment, the obtaining module 81 is further specifically configured to: perform the measurement based on the measurement configuration information to obtain location-related information and channel state information of at least one cell; and determine the one or more target cells in the at least one cell based on the location-related information to obtain the one or more early measurement results of the one or more target cells.

In a possible embodiment, the obtaining module 81 is further specifically configured to perform an location measurement based on the measurement configuration information to obtain location-related information of at least one cell; determine the one or more target cells in the at least one cell based on the location-related information; perform an channel state measurement on the one or more target cells to obtain channel state information of the one or more target cells; and obtain the one or more early measurement results of the one or more target cells based on the channel state information and the location-related information of the one or more target cells.

The communication apparatus provided by the embodiment of the present disclosure may execute the technical solutions illustrated in the above method embodiments, and its realization principle and beneficial effect are similar, so it will not be repeated in the present disclosure.

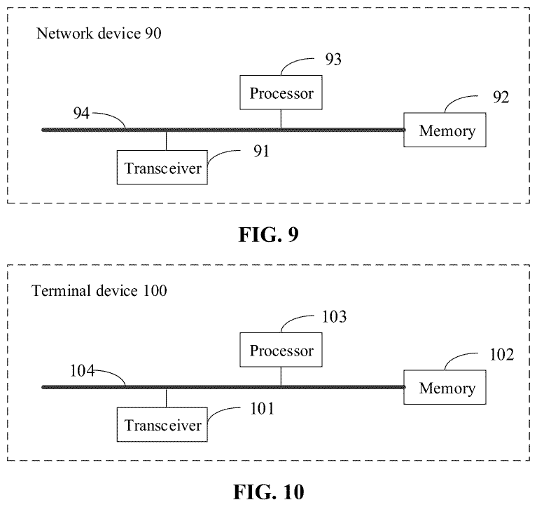

FIG. 9 is a schematic structural diagram of a network device provided by an embodiment of the present disclosure. Referring to FIG. 9, the network device 90 includes a transceiver 91, a memory 92 and a processor 93. The transceiver 91 may include a transmitter and/or receiver. The transmitter may also be referred to as a sender, a transmitting machine, a transmitting port or a transmitting interface or the like, and the receiver may also be referred to as a receiving machine, a receiving port or a receiving interface or the like. Exemplarily, the transceiver 91, the memory 92 and the processor 93 are interconnected via a bus 94.

The memory 92 is configured to store program instructions.

The processor 93 is configured to execute the program instructions stored in the memory to cause the network device 90 to perform any of the above-described communication methods.

The receiver of the transceiver 91 may be configured to perform the receiving function of the network device in the above communication methods.

FIG. 10 is a schematic structural diagram of a terminal device provided by an embodiment of the present disclosure. Referring to FIG. 10, the terminal device 100 includes a transceiver 101, a memory 102 and a processor 103. The transceiver 101 may include a transmitter and/or receiver. The transmitter may also be referred to as a sender, a transmitting machine, a transmitting port or a transmitting interface or the like, and the receiver may also be referred to as a receiving machine, a receiving port or a receiving interface or the like. Exemplarily, the transceiver 101, the memory 102 and the processor 103 are interconnected via a bus 104.

The memory 102 is configured to store program instructions.

The processor 103 is configured to execute the program instructions stored in the memory to cause the terminal device 100 to execute any of the above-described communication methods.

The receiver of the transceiver 101 may be used to perform the receiving function of the terminal device in the communication methods.

Embodiments of the present disclosure provide a computer readable storage medium. The instructions executable by a computer are stored in the computer readable storage medium. When the instructions executable by the computer are executed by a processor, the above communication method is implemented.

In the communication method and the communication apparatus provided by the embodiments of the present disclosure, the terminal device first obtains early measurement results of multiple cells, and then transmits the early measurement results to the network device. After receiving the early measurement results of the multiple cells, the network device can determine one or more to-be-configured or to-be-activated cells in the multiple cells based on the early measurement results. Because the early measurement result includes the location-related information, the network device can evaluate the channel quality by combining the RSRP or RSRQ and the location-related information. Compared with the solution of evaluating the channel quality only based on the RSRP or RSRQ, the error in judging the channel quality caused by the measurement error can be reduced effectively, which is helpful for the network device to activate or configure the cell with better channel quality, thereby improving the subsequent data transmission efficiency of the terminal device on the cell.

Embodiments of the present disclosure provide a computer program product, which may be executed by a processor. When the computer program product is executed, the communication method executed by the terminal device or the network device as described above may be implemented.

The communication device, the computer readable storage medium and the computer program product in the embodiments of the present disclosure can be used to perform the above communication methods executable by the terminal device and the network device, the detail implementation processes and the beneficial effects can be referred to the above, which are not repeated in the present disclosure.

In several embodiments provided in the present disclosure, it should be understood that the disclosed systems, apparatuses and methods may be implemented in other ways. For example, the above-described embodiments of the apparatus are only schematic, for example, the division of the units is only a logical function division, and in practice, there may be another division mode, for example, multiple units or components may be combined or integrated into another system, or some features may be ignored or not performed. On the other hand, the coupling, direct coupling or communication connection between each other shown or discussed may be indirect coupling or communication connection through some interface, apparatus or unit, and may be electrical, mechanical or other form.

The units illustrated as separate components may or may not be physically separated, and the components displayed as units may or may not be physical elements, that is, may be located in one place, or may be distributed over a plurality of network elements. Part or all of the units may be selected according to the actual needs to achieve the purpose of the embodiments. In addition, various functional units in various embodiments of the present disclosure may be integrated in one processing unit, each unit may exist physically alone, or two or more units may be integrated in one unit. The above integrated unit may be realized either in the form of hardware or in the form of software functional unit.

Those of ordinary skill in the art will appreciate that all or part of the operations to implement the above-described method embodiments may be accomplished by hardware associated with program instructions. The above computer programs may be stored in a computer readable storage medium. When the computer programs are executed by the processor, the operations including the above-mentioned method embodiments are implemented. The aforementioned storage medium includes various medium capable of storing program codes such as a ROM, a RAM, a magnetic disk or an optical disk.

Finally, it should be noted that the above embodiments are only used to illustrate the technical solutions of the present disclosure, but not to limit it. Although the present disclosure has been described in detail with reference to the foregoing embodiments, it should be understood by those of ordinary skill in the art that the technical solutions described in the foregoing embodiments may still be modified or some or all of the technical features thereof may be equivalently replaced; These modifications or substitutions do not depart the essence of the corresponding technical solutions from the scope of the technical solutions of various embodiments of the present disclosure.

1. A method for communication, performed by a terminal device, the method comprising:
obtaining one or more early measurement results of one or more target cells, wherein each of the one or more early measurement results comprises respective location-related information; and
transmitting the one or more early measurement results to a network device.

2. The method of claim 1, wherein the location-related information comprises at least one of:
a distance from the terminal device to a satellite;
a distance from the terminal device to a ground reference point of a cell;
a timing advance (TA) value from the terminal device to the cell;
a round-trip time (RTT) value from the terminal device to the cell;
a RTT value from the terminal device to the satellite; or
a global navigation satellite system (GNSS) location of the terminal device.

3. The method of claim 1, further comprising: before obtaining the one or more early measurement results of the one or more target cells,
receiving measurement configuration information from the network device; and
performing a measurement based on the measurement configuration information to obtain the one or more early measurement results of the one or more target cells.

4. The method of claim 3, wherein receiving the measurement configuration information from the network device comprises:
receiving a system information block (SIB) message from the network device and obtaining the measurement configuration information based on the SIB message; or
receiving a radio resource control (RRC) signaling from the network device, and obtaining the measurement configuration information based on the RRC signaling.

5. The method of claim 3, wherein the measurement configuration information comprises at least one of:
location reporting assistance information; or
location reporting condition information.

6. The method of claim 5, wherein the location reporting assistance information comprises at least one of:
ephemeris information of a satellite associated with one or more cells; or
one or more ground reference points of the one or more cells.

7. The method of claim 5, wherein the location reporting condition information comprises at least one of:
a first distance threshold from the terminal device to a satellite;
a second distance threshold from the terminal device to a ground reference point of a cell;
a TA threshold from the terminal device to the cell;
a first RTT threshold from the terminal device to the cell; or
a second RTT threshold from the terminal device to the satellite.

8. The method of claim 7, wherein at least one of the following applies:
when the location reporting condition information comprises the first distance threshold, a distance from the terminal device to a satellite associated with the one or more target cells is less than or equal to the first distance threshold;
when the location reporting condition information comprises the second distance threshold, a distance from the terminal device to one or more ground reference points of the one or more target cells is less than or equal to the second distance threshold;
when the location reporting condition information comprises the TA threshold, a TA value from the terminal device to the one or more target cells is less than or equal to the TA threshold;
when the location reporting condition information comprises the first RTT threshold, a RTT value from the terminal device to the one or more target cells is less than or equal to the first RTT threshold; or
when the location reporting condition information comprises the second RTT threshold, a RTT value from the terminal device to the satellite associated with the one or more target cells is less than or equal to the second RTT threshold.

9. A network device, comprising:
a transceiver, configured to receive, from a terminal device, one or more early measurement results of one or more target cells, wherein each of the one or more early measurement results comprises respective location-related information; and
a processor, configured to determine, based on the one or more early measurement results, one or more to-be-configured or to-be-activated cells in the one or more target cells.

10. The network device of claim 9, wherein the location-related information comprises at least one of:
a distance from the terminal device to a satellite;
a distance from the terminal device to a ground reference point of a cell;
a timing advance (TA) value from the terminal device to the cell;
a round-trip time (RTT) value from the terminal device to the cell;
a RTT value from the terminal device to the satellite; or
a global navigation satellite system (GNSS) location of the terminal device.

11. The network device of claim 9, wherein the transceiver is further configured to transmit measurement configuration information to the terminal device before receiving, from the terminal device, the one or more early measurement results of the one or more target cells.

12. The network device of claim 10, wherein the transceiver is further configured to:
transmit a system information block (SIB) message to the terminal device, wherein the SIB message comprises the measurement configuration information; or
transmit a radio resource control (RRC) signaling to the terminal device, wherein the RRC signaling comprises the measurement configuration information.

13. A terminal device, comprising:
a processor, configured to obtain one or more early measurement results of one or more target cells, wherein each of the one or more early measurement results comprises respective location-related information; and
a transceiver, configured to transmit the one or more early measurement results to a network device.

14. The terminal device of claim 13, wherein the location-related information comprises at least one of:
a distance from the terminal device to a satellite;
a distance from the terminal device to a ground reference point of a cell;
a timing advance (TA) value from the terminal device to the cell;
a round-trip time (RTT) value from the terminal device to the cell;
a RTT value from the terminal device to the satellite; or
a global navigation satellite system (GNSS) location of the terminal device.

15. The terminal device of claim 13, wherein the processor is further configured to: before obtaining the one or more early measurement results of the one or more target cells,
receive, through the transceiver, measurement configuration information from the network device; and
perform an measurement based on the measurement configuration information to obtain the one or more early measurement results of the one or more target cells.

16. The terminal device of claim 14, wherein the processor is further configured to:
receive, through the transceiver, a system information block (SIB) message from the network device and obtain the measurement configuration information based on the SIB message; or
receive, through the transceiver, a radio resource control (RRC) signaling from the network device and obtain the measurement configuration information based on the RRC signaling.

17. The terminal device of claim 15, wherein the measurement configuration information comprises at least one of:
location reporting assistance information; or
location reporting condition information.

18. The terminal device of claim 17, wherein the location reporting assistance information comprises at least one of:
ephemeris information of a satellite associated with one or more cells; or
one or more ground reference points of one or more cells.

19. The terminal device of claim 17, wherein the location reporting condition information comprises at least one of:
a first distance threshold from the terminal device to a satellite;
a second distance threshold from the terminal device to a ground reference point of a cell;
a TA threshold from the terminal device to the cell;
a first RTT threshold from the terminal device to the cell; or
a second RTT threshold from the terminal device to the satellite.

20. The terminal device of claim 19, wherein at least one of the following applies:
when the location reporting condition information comprises the first distance threshold, a distance from the terminal device to a satellite associated with the one or more target cells is less than or equal to the first distance threshold;
when the location reporting condition information comprises the second distance threshold, a distance from the terminal device to one or more ground reference points of the one or more target cells is less than or equal to the second distance threshold;
when the location reporting condition information comprises the TA threshold, a TA value from the terminal device to the one or more target cells is less than or equal to the TA threshold;
when the location reporting condition information comprises the first RTT threshold, a RTT value from the terminal device to the one or more target cells is less than or equal to the first RTT threshold; or
when the location reporting condition information comprises the second RTT threshold, a RTT value from the terminal device to the satellite associated with the one or more target cells is less than or equal to the second RTT threshold.
